(19) United States
(12) Patent Application Publication
(10) Pub. No.: US 2003/0161933 A1
(43) Pub. Date: Aug. 28, 2003

(54) Dispensing a beverage

(75) Inventors: Iain Wallace Anderson, Staffordshire (GB); Peter Thomas Foster, Staffordshire (GB); Stuart William Molzahn, Derbyshire (GB); Stephen Paul Smith, Derbyshire (GB); Wendy Gladys, Staffordshire (GB); Rachel Joanna Galt, Staffordshire (GB); David Edwin Quain, Staffordshire (GB); Robert Alan Wright, Derbyshire (GB)

Correspondence Address: BAKER & BOTTS, 30 ROCKEFELLER PLAZA, NEW YORK, NY, 10112

(73) Assignee: Coors Worldwide Inc., Golden, CO

(21) Appl. No.: 10/339,235

(22) Filed: Jan. 9, 2003

Related U.S. Application Data
(63) Continuation-in-part of application No. 09/700,512, filed on Jan. 12, 2001.
Application No. 09/700,512 is a 371 of international application No. PCT/GB99/01551, filed on May 14, 1999.
(63) Continuation-in-part of application No. PCT/GB99/03824, filed on Nov. 17, 2002.

(30) Foreign Application Priority Data
May 15, 1998 (GB) 9810309.6
Dec. 23, 1998 (GB) 9828321.1
Dec. 23, 1998 (GB) 9828317.9
Jan. 19, 1999 (GB) 9901018.3

(51) Int. Cl. C12G 1/00

(52) U.S. Cl. 426/592

(57) ABSTRACT

A method of dispensing a draught beverage, for example a beer, having a water content and a dissolved gas content; the beverage issuing from a mixing nozzle 24 into a drinking glass 26. The beverage is subjected to nucleation causing nucleation sites to occur in the beverage, at which sites ice is encouraged to form. Draught beverage from a beverage supply 12 is initially cooled by chiller 16 before reaching the mixing nozzle 24 in which the beverage mixes with coolant from a coolant supply 14 before going into the glass 26. This mixing and cooling by the coolant in the mixing nozzle causes nucleation and ice to form in the beverage before it is delivered into the glass. The coolant may be cold liquified gas, for example liquid nitrogen, or may be solid carbon dioxide.

### RELATED APPLICATIONS

This application is a continuation-in-part of patent application Ser. No. 700,512 which is the derived from international patent application No. PCT/GB99/01551 filed May 14, 1999 and a continuation-in-part of patent application Ser. No. 150,463 which is derived from international patent application No. PCT/GB99/03824) filed Nov. 17, 1999.

### FIELD OF THE INVENTION

This invention concerns a method of dispensing a draught beverage.

The invention also concerns dispensed draught beverage, and apparatus for use in dispensing the beverage.

### SUMMARY OF THE INVENTION

The present invention provides a method of dispensing a beverage comprising cooling the beverage, providing a nucleation substance, and adding the nucleation substance to the cooled beverage thereby to provide nucleation sites whereby ice forms in the beverage at the nucleation sites.

Preferably the ice is formed as crystals. The crystals are preferably free-floating in the beverage.

Preferably the nucleation substance is cooled before being added to the beverage. More preferably the nucleation substance has a phase change temperature and is cooled to below the phase change temperature so that it undergoes a phase change. Still more preferably the beverage is cooled to a temperature which is higher than the phase change temperature such that nucleation substance undergoes a phase change when it has been added to the beverage. Said phase change may be from a gas phase to a liquid phase, or from a liquid phase to a solid phase. The nucleation substance may be cooled from a gas to a liquid prior to undergoing said phase change. The nucleation substance may, for example, carbon dioxide or water.

The nucleation substance may be added to the beverage in the vessel. For example the nucleation substance may be introduced into the vessel simultaneously with at least some of said beverage. The nucleation substance may be pre-mixed with the beverage prior to the beverage being dispensed into the vessel.

Preferably the beverage is an alcoholic beverage and the nucleation substance is water and delivered in such quantity as to dilute the beverage to a pre-determined alcoholic strength. For example the pre-determined alcoholic strength may be between 2% and 8%, more preferably from between 4% and 6%, still more preferably substantially 6% alcohol by volume (ABV).

The nucleation substance may be a fluid in which case it may be introduced in a form of a fine stream.

The nucleation substance may be introduced into the vessel through a narrow nozzle, which may be in the form of a needle, entering the vessel through a wall of the vessel. Preferably said wall has at least a portion formed of self-sealing resilient material which is pierced by said nozzle.

Preferably the nucleation sites in the beverage contributing to formation of a head on the beverage. Preferably the beverage is a draught beverage, which may comprises a water content and a dissolved gas content. More preferably the beverage is alcoholic. For example the alcoholic beverage may be a beer, such as lager, or cider.

The nucleation substance can be added in the form of a solid. For example the nucleation substance may comprise yeast. Alternatively the nucleation substance may comprise at least one of proteins and polyphenolic substances.

The present invention further provides apparatus for the delivery of a beverage to a vessel, said apparatus comprising a source of cooled beverage, a beverage nozzle for delivery of the beverage and a nucleation substance adding means arranged to add a nucleation substance to the beverage thereby to provide nucleation sites in the beverage whereat ice can form.

The source of cooled beverage preferably includes a beverage cooler, and a beverage dispensing system arranged.to dispense beverage cooled by the cooler. Preferably the dispensing system includes a dispense tap, and more preferably it includes a font, for example at a drinks bar.

Preferably the adding means comprises a nozzle, for example it may be within the beverage nozzle. Alternatively the adding means may comprise an orifice plate.

Preferably the nucleation substance adding means includes a cooler arranged to cool the nucleation substance prior to its being added to the beverage.

The present invention further provides beverage in a vessel having been dispensed into the vessel by the method of the invention.

The present invention further provides beverage in a vessel having been dispensed into the vessel by an apparatus according the invention.

The present invention further provides a method of dispensing a draught beverage comprising cooling the beverage, and adding a nucleation substance to the cooled beverage thereby to provide nucleation sites whereby ice forms in the beverage at the nucleation sites, wherein the nucleation substance is added in particulate form.

The nucleation substance may have a melting temperature and is cooled to below the melting temperature to allow it to be provided in said particulate form. Alternatively the nucleation substance may be yeast, which preferably forms a suspension in the beverage. As a further alternative the nucleation substance may appear as a chill haze in the beverage.

The present invention still further provides a method of dispensing a draught beverage comprising providing a beverage having particulate material therein, and cooling the beverage such that the particulate material provides nucleation sites whereby ice forms in the beverage at the nucleation sites. The draught beverage may be a cask beverage which has not been cask conditioned. Furthermore the beverage has preferably not been treated prior to dispense, to remove said yeast particles.

The beverage is preferably a draught beverage.

Preferred embodiments of the invention will now be further described, by way of example, with reference to the accompanying drawings.

### BRIEF DESCRIPTION OF THE DRAWINGS

FIG. 1 is a schematic representation of an apparatus according to a first embodiment of the invention;

FIG. 2 is a schematic representation of an apparatus according to a second embodiment of the invention;

FIG. 3 is a schematic side view of apparatus according a third embodiment of the invention;

FIG. 4 is a schematic side view of an apparatus according to a fourth embodiment of the invention;

FIG. 5 is a schematic side view of an apparatus according to a fifth embodiment of the invention; and

FIG. 6 is a schematic view of an apparatus according to a sixth embodiment of the invention.

### DESCRIPTION OF THE PREFERRED EMBODIMENTS

With reference to FIG. 1, a dispensing apparatus 10 for dispensing draught beverage comprises a draught beverage supply 12 in the form of a barrel of lager, a coolant supply 14, a chiller 16, valves 18, 20, a control system 22 and a mixing head 24. The beverage supply 12 is connected to the mixing head via one 18 of the valves and the coolant supply 14 is connected to the mixing head 24 via the other 20 of the valves.

The control system 22 operates the valves 18, 20 to control the flow of beverage and coolant from their respective supplies 12, 14 into the mixing head 24. The supplies 12, 14 will generally included a pump (not shown) so that the beverage and coolant are supplied under pressure, so that opening the valves 18, 20 will cause the beverage and coolant respectively to flow to the mixing head 24.

Independent operation of the valves 18, 20 allows either the beverage or coolant to pass freely through the mixing head 25 and be dispensed into a drinking vessel in the form of a glass 26. Therefore in a first mode of operation, the valve 18 is opened to allow beverage, which has been supercooled in the chiller 16, to flow into the glass 26. Then the valve 18 is closed and the valve 20 opened to allow a volume of coolant to flow into the beverage in the glass 26. The coolant forms nucleation sites which promote the crystallization of ice in the beverage resulting in free-floating ice crystals in the beverage.

The simultaneous opening of the valves 18, 20 draws both the beverage and coolant into the mixing head 24. Therefore in a second mode of operation the valves 18, 20 are opened simultaneously and the beverage and coolant mix in the mixing head 24 wherein ice formation occurs prior to the final dispensing of the mixture into the glass 26.

In a further mode of operation the beverage is not supplied in a supercooled state, and the cooling effect of the coolant on the beverage promotes the formation of ice in the beverage when the coolant and beverage are mixed.

The coolant is typically a liquefied gas, in this example liquid nitrogen. The coolant may however be solid carbon dioxide in which case the coolant supply 14 will typically be mounted directly above the mixing head 24 and the valve 18 may take the form of a gate valve.

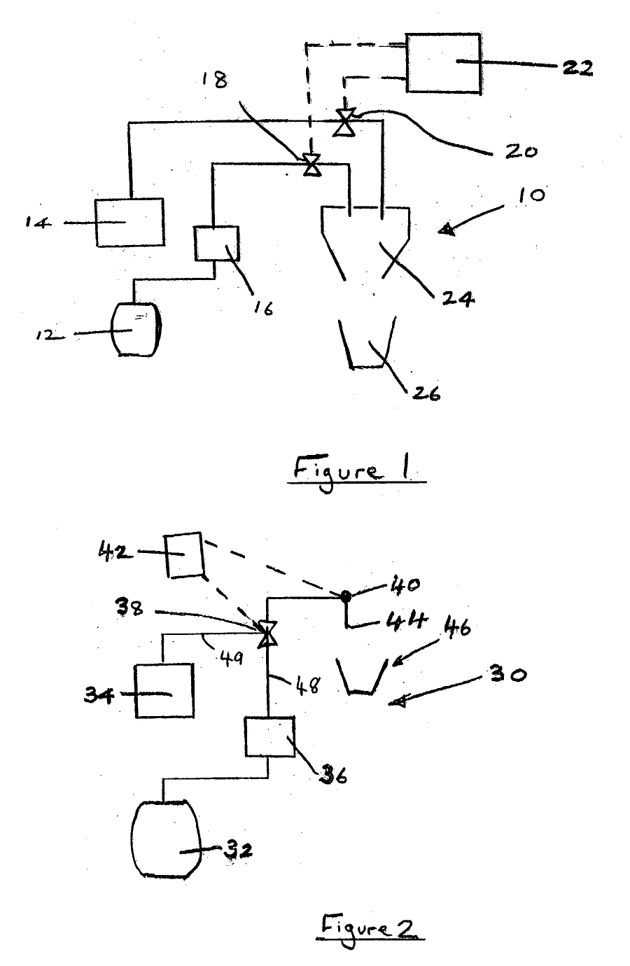

Referring now to FIG. 2, a draught beverage dispensing system 30 according to a second embodiment of the invention includes a beverage supply 32, a coolant supply 34, a chiller 36, a valve 38, a temperature sensor 40, a control unit 42, and a dispense nozzle or head 44. The beverage supply 32 is connected via the chiller 36 and the valve 38, by means of a supply pipe 48 to the nozzle 44. The chiller 36 is connected to the valve 38 by means of a coolant supply pipe 49, so that the valve 38 can control the amount of beverage flowing to the nozzle 44, and the amount of coolant entering the beverage pipe 49.

In use, the control unit 42 controls the valve 38 regulating the amount of coolant entering the beverage from the coolant supply 34. This may be regulated manually by the use of, for example, a key pad or alternatively by a feedback loop incorporating the temperature sensor 40.

The manual operation of the control unit 42 and valve 38 allows either only coolant or only beverage or a mixture of the two to be dispensed via the head 44 into a glass 46.

The temperature sensor 40 acts via the feedback loop with the control unit to maintain the mixture of beverage and coolant at a constant predetermined temperature. This temperature can be set so as to allow the formation of a predetermined proportion of ice within the mixture prior to dispensing.

It will be appreciated that the manual operation of the valve 38 could also be used to allow ice formation within a beverage/coolant mixture prior to its dispensing.

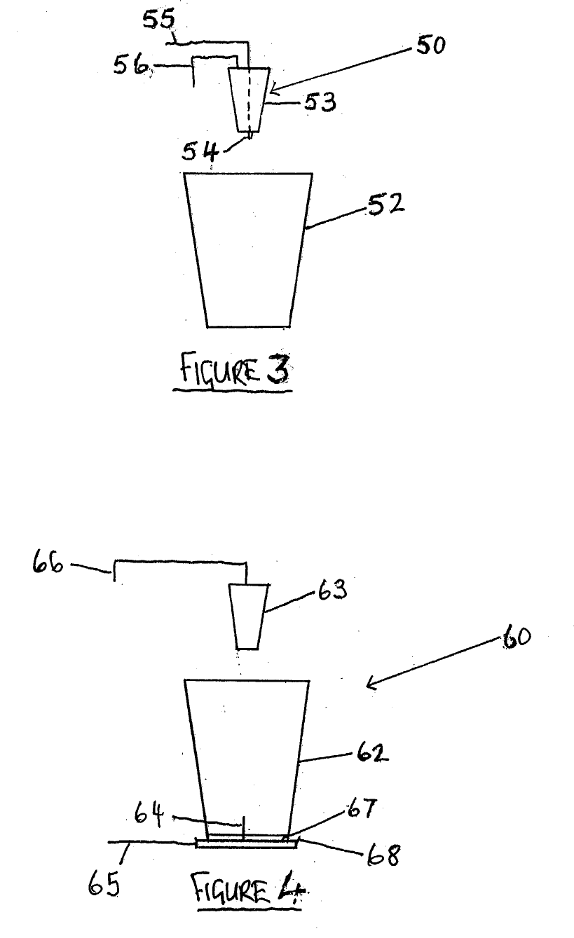

FIG. 3 shows an apparatus 50 suitable for filling a drinking vessel or glass 52 with a draught beverage. The apparatus 50 possesses a beverage nozzle 53 which is connected to a beverage supply line 56. Provided within the beverage nozzle 53 is a nucleation fluid nozzle 54 which is connected to a nucleation fluid supply line 55. The nucleation fluid may be a liquid, for example water, especially cold water, or liquid nitrogen, or a gas, especially a cooled gas, for example nitrogen or carbon dioxide. In use, cooled beverage is supplied to the beverage nozzle 53 and forms a stream from the nozzle 53 into the vessel 52, and the nucleation fluid is dispensed into the centre of the stream of beverage from the beverage nozzle 53. If the fluid is a liquid it will become mixed with the beverage in the vessel wherein it will promote the formation of ice crystals. If the fluid is a gas it will become entrained in the beverage to form bubbles as the beverage enters the vessel, and the bubbles form nucleation sites which promote the formation of ice crystals in the beverage. The beverage may be supercooled to below its freezing point to encourage the formation of ice, or it may be cooled to close to its freezing point and the nucleation fluid may also be cooled and used to cool the beverage further to promote the formation of ice.

In a modification to the embodiment of FIG. 3 the nucleation fluid nozzle 54 can be separate from or external to the beverage nozzle.

FIG. 4 shows an apparatus 60 suitable for filling a drinking vessel 62 with a draught beverage. The vessel 62 is provided with a base 67 of resilient self-sealing material which may be pierced and the vessel 62 rests on support 68. The base 67 is formed from rubber. The apparatus 60 possesses a beverage nozzle 63 which is connected to a beverage supply line 66. The support 68 is provided with nucleation fluid nozzle 64 which is connected to nucleation fluid supply line 65. The nucleation fluid nozzle 64 is in the form of a hypodermic needle which pierces the base 67 of the vessel 62. The base 67 self-seals when removed from nozzle 64. In use, the beverage is placed onto the support 68 so that the needle 64 pierces its base 67, which forms a fluid-tight seal around the needle. The beverage is then dispensed into the vessel 62. Nucleation fluid is then injected as a narrow jet into the beverage in the vessel through the needle 64. The vessel 64 is then lifted off the needle 64 and its base 67 seals up to make the vessel water-tight. Again pre-cooling of the beverage and cooling of the nucleation fluid can each be used to provide sufficiently low temperature for ice formation.

The addition of said nucleation fluid into the beverage in the vessel 52 or 62 promotes the formation of ice in the beverage, especially if the beverage is prior cooled immediately before dispense from the nozzle 53 or 63. It is believed that the nucleation fluid provides or creates nucleation sites within the beverage, which sites promote the formation of ice.

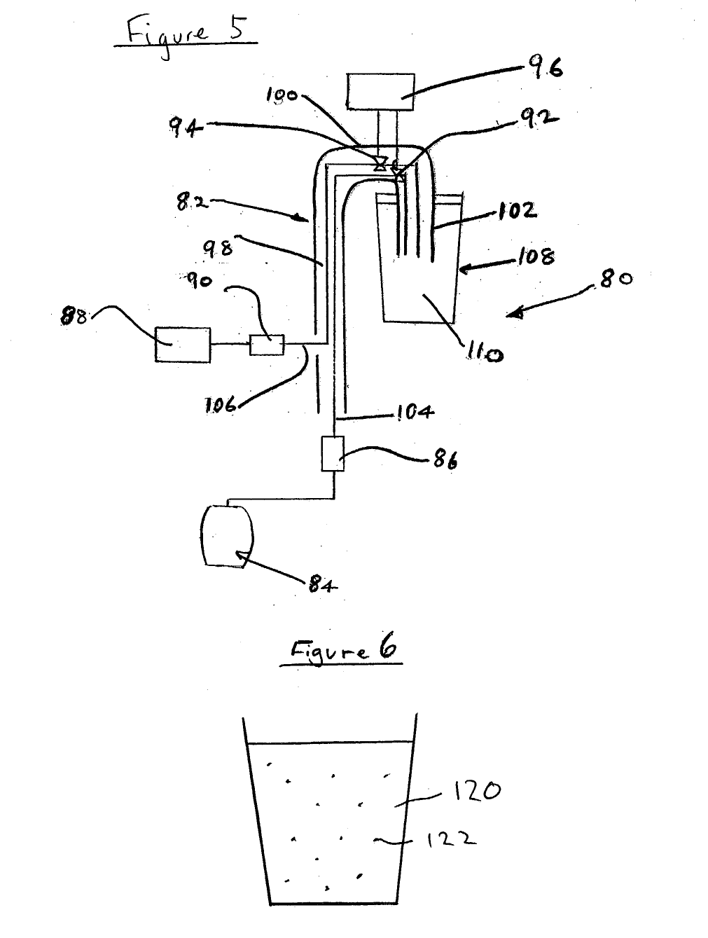

With reference to FIG. 5, a draught beverage dispensing apparatus 80 includes a font 82, a draught beverage supply 84, a beverage chiller 86, a gas supply 88, a gas chiller 90, valves 92, 94 and a control unit 96.

The font 82 has hollow elongate body 98, arm 100 and head 102 portions. Beverage and gas supply pipes 104, 106 enter the body 98 and pass through the arm 100 and terminate internally of, and adjacent an open free end of, the head 102.

In use, the valves 92, 94 regulate the flow of beverage and gas through their respective supply pipes 104, 106 to exit through the head 102 in response to the control unit 96. A drinking vessel or glass 108 is placed under, or around, the head 102 and draught beverage 110 dispensed thereinto under pressure in response to the valve 92 being opened by the control unit 96.

The head 102 is at least partially submerged in the beverage 110 during and after dispensing, and the valve 94 is operated to allow gas to pass through the chiller 90 along the supply pipe 106 and enter the beverage 110, but during and after dispense of the beverage.

The gas bubbles introduced into the beverage 110 from gas supply 88 act as nucleation sites for ice formation where the beverage is chilled below the freezing point of water. Supply 88 can be a supply of carbon dioxide and/or nitrogen.

The control unit 96 can be electrically operated and include a user input in the form of, for example, a keypad to allow control of the valves 92, 94. Alternatively it can comprise a manual such as a valve lever. It will also be appreciated that various modifications can be made to the apparatus, for example the gas chiller 90 can be omitted. It will be further appreciated that the drinking vessel 102 may be illuminated and/or mounted on a rotatable platform during dispensing of the beverage.

Referring to FIG. 6, in a sixth embodiment of the invention a particulate nucleation substance is added to the supercooled beverage 120 in the form of yeast 122. The yeast provides a degree of clouding of the beverage, which can be desirable for example of the beverage is beer, and also promotes the formation of ice in the beverage.

In a modification to this embodiment further particulate substances such as proteins or polyphenolic substances are added in place of yeast. These substances are naturally resent in cask conditioned beer and their presence can be considered desirable under certain circumstances.

In a further modification to this embodiment, rather than adding yeast to the beverage, the beverage is in the form of cask beer which has not been conditioned, and therefore contains yeast and other particulate substances such as proteins or polyphenolic substances. These particulate substances which are already in the beverage when it is dispensed therefore form the nucleation substance, and no further substances have to be added to the beverage, provided it is sufficiently chilled, to promote the formation of ice.

In the embodiments described above the draught beverage may be cooled prior to delivering into the vessel, for example using beverage cooling means in a beverage dispensing system which may convey beverage from a supply of beverage to a dispense tap or a font at, for example, a drinks bar. The beverage may be non-alcoholic or alcoholic. For example, an alcoholic beverage may be a beer, for example a lager or an ale, stout or porter or the alcoholic beverage may be cider.

1. A method of dispensing a beverage comprising cooling the beverage, providing a nucleation substance, and adding the nucleation substance to the cooled beverage thereby to provide nucleation sites whereby ice forms in the beverage at the nucleation sites.

2. A method according to claim 1 wherein the ice is formed as crystals.

3. A,method according to claim 2 wherein the crystals are free-floating in the beverage.

4. A method according to claim 1 wherein the beverage is dispensed into a vessel.

5. A method according to claim 1 wherein the nucleation substance is cooled before being added to the beverage.

6. A method according to claim 5 wherein the nucleation substance has a phase change temperature and is cooled to below the phase change temperature so that it undergoes a phase change.

7. A method according to claim 6 wherein the beverage is cooled to a temperature which is higher than the phase change temperature such that nucleation substance undergoes a phase change when it has been added to the beverage.

8. A method according to claim 6 wherein said phase change is from a gas phase to a liquid phase.

9. A method according to claim 6 wherein said phase change is from a liquid phase to a solid phase.

10. A method according to claim 9 wherein the nucleation substance is cooled from a gas to a liquid prior to undergoing said phase change.

11. A method according to claim 10 wherein the nucleation substance is carbon dioxide.

12. A method according to claim 9 wherein the nucleation substance is water.

13. A method according to claim 4 wherein the nucleation substance is added to the beverage in the vessel.

14. A method according to claim 13 wherein the nucleation substance is introduced into the vessel simultaneously with at least some of said beverage.

15. A method according to claim 4 wherein the nucleation substance is pre-mixed with the beverage prior to the beverage being dispensed into the vessel.

16. A method according to claim 1 wherein the beverage is an alcoholic beverage and the nucleation substance is water and delivered in such quantity as to dilute the beverage to a pre-determined alcoholic strength.

17. A method as claimed in claim 16 in which said pre-determined alcoholic strength is substantially 6% alcohol by volume (ABV).

18. A method as claimed in claim 1 wherein the nucleation substance is a fluid and is introduced in a form of a fine stream.

19. A method as claimed in claim 4 in which the nucleation substance is introduced into the vessel through a narrow nozzle entering the vessel through a wall of the vessel.

20. A method according to claim 19 wherein said narrow nozzle comprises a needle.

21. A method according to claim 20 wherein said wall has at least a portion formed of self-sealing resilient material which is pierced by said nozzle.

22. A method as claimed in claim 1 in which the nucleation sites in the beverage contributing to formation of a head on the beverage.

23. A method as claimed in claim 1 in which the draught beverage comprises a water content and a dissolved gas content.

24. A method as claimed in claim 1 in which the vessel is a drinking vessel.

25. A method as claimed in claim 24 in which the drinking vessel is a glass.

26. A method as claimed claim 1 in which the draught beverage is alcoholic.

27. A method as claimed in claim 26 in which the alcoholic beverage is a beer or cider.

28. A method as claimed in claim 27 in which the beer is lager.

29. A method as claimed in claim 4 in which beverage cooled prior to its delivery into the vessel.

30. A method according to claim 1 wherein the nucleation substance is added in the form of a solid.

31. A method according to claim 30 wherein the nucleation substance is yeast.

32. A method according to claim 1 wherein the nucleation substance comprises at least one of proteins and polyphenolic substances.

33. An apparatus for the delivery of a beverage to a vessel, said apparatus comprising a source of cooled beverage, a beverage nozzle for delivery of the beverage and a nucleation substance adding means arranged to add a nucleation substance to the beverage thereby to provide nucleation sites in the beverage whereat ice can form.

34. Apparatus according to claim 33 in which the source of cooled beverage includes a beverage cooler, and a beverage dispensing system arranged to dispense beverage cooled by the cooler.

35. Apparatus according to claim 34 wherein the beverage dispensing system includes a dispense tap.

36. Apparatus according to claim 34 wherein the dispensing system includes a font.

37. Apparatus according to claim 36 wherein the font is at a drinks bar.

38. Apparatus according to claim 33 wherein the adding means comprises a nozzle.

39. Apparatus according to claim 38 wherein the adding means is within the beverage nozzle.

40. Apparatus according to claim 33 wherein the adding means comprises an orifice plate.

41. Apparatus according to claim 34 wherein the nucleation substance adding means includes a cooler arranged to cool the nucleation substance prior to its being added to the beverage.

42. Beverage in a vessel having been dispensed into the vessel by a method as claimed in claim 4.

43. Beverage in a vessel having been dispensed into a vessel by an apparatus according to claim 33.

44. A method of dispensing a draught beverage comprising cooling the beverage, and adding a nucleation substance to the cooled beverage thereby to provide nucleation sites whereby ice forms in the beverage at the nucleation sites, wherein the nucleation substance is added in particulate form.

40. A method according to claim 39 wherein the nucleation substance has a melting temperature and is cooled to below the melting temperature to allow it to be provided in said particulate form.

41. A method according to claim 39 wherein the nucleation substance is yeast.

42. A method according to claim 41 wherein the yeast forms a suspension in the beverage.

43. A method according to claim 39 wherein the nucleation substance appears as a chill haze in the beverage.

44. A method of dispensing a draught beverage comprising providing a beverage having particulate material therein, and cooling the beverage such that the particulate material provides nucleation sites whereby ice forms in the beverage at the nucleation sites.

45. A method according to claim 44 wherein the nucleation substance is yeast.

46. A method according to claim 44 wherein the yeast forms a suspension in the beverage.

47. A method according to claim 44 wherein the nucleation substance appears as a chill haze in the beverage.

48. A method according to claim 45 in which the draught beverage is a cask beverage which has not been cask conditioned.

49. A method according to claim 45 in which the beverage has not been treated prior to dispense, to remove said yeast particles.

50. A method according to claim 1 wherein the beverage is a draught beverage.

51. Apparatus according to 33 which is arrange to dispense the beverage as a draught beverage.
